(19) United States
(12) Patent Application Publication
(10) Pub. No.: US 2006/0278684 A1
(43) Pub. Date: Dec. 14, 2006

(54) Jig and method for connecting connection members using the same

(76) Inventors: Tomonari Ohtsuki, Tokyo (JP); Yasue Yamazaki, Tokyo (JP)

Correspondence Address: BAKER & BOTTS, 30 ROCKEFELLER PLAZA, 44TH FLOOR, NEW YORK, NY, 10112, US

(21) Appl. No.: 11/481,375

(22) Filed: Jul. 5, 2006

Related U.S. Application Data
(63) Continuation-in-part of application No. 10/712,470, filed on Nov. 13, 2003, now abandoned.

(30) Foreign Application Priority Data
Apr. 24, 2003 (JP) 2003-119,206

(51) Int. Cl. B23K 37/04

(52) U.S. Cl. 228/49.1

(57) ABSTRACT

A jig to be in contact with solder in reflow soldering is coated with diamond-like-carbon on at least a portion which is to be in contact with the solder. In this manner the solder is prevented from adhering to the jig. The diamond-like-carbon coating is preferably provided on the whole surface of the jig facing to the molten solder. In a method for connecting connection members using a jig which can be in contact with solder in reflow soldering, the jig is coated with the diamond-like-carbon on its surface which is likely to contact the solder.

### PRIORITY INFORMATION

The present application is a continuation in part of application Ser. No. 10/712,470, filed Nov. 13, 2003, which claims priority to Japanese Application No. 2003-119,206 filed Apr. 24, 2003, each of which are incorporated by reference herein, and from which priority is claimed.

### BACKGROUND OF THE INVENTION

The present invention relates to a jig to be used in reflow soldering, and more particularly to a jig capable of preventing adhesion of solder thereto in reflow soldering and a method for connecting connection members by reflow soldering using the jig.

FIG. 4A illustrates a connector 10 by means of which problems noted with prior art jigs will be explained. The connector 10 is of a surface mounting type (SMT) and comprises an insulating housing 12 and a plurality of contacts 14. Contact tails 16 which are connection portions of the contacts 14 to be connected to a board are often different in height as shown in FIG. 4B so that there is a need for forcing the contact tails 16 against the board by a jig 18 when the contact tails 16 are connected to the board by reflow soldering, thereby ensuring stable connection therebetween.

When the jig is used for urging the contact tails 16 to the board, there would be possibility of adhesion by solder between the jig 18 and the contact tails 16 or the board, which is a problem to be solved.

A prior art proposal has attempted to overcome the problem by a surface treatment of the jig. In the proposal, the jig is partly nickel-plated and treated with anode oxidation for the purpose of preventing adhesion of solder and enhancing corrosion resistance. However, complete prevention of solder adhesion is very difficult by this attempt, and the oxide film on the jig is progressively damaged in every reflow soldering. With an oxide film of a thickness of 5 μm, the oxide film is completely diminished when the jig has been used only about ten times for reflow soldering, and thereafter the jig is bonded to contact tails or a board by solder.

### SUMMARY OF THE INVENTION

It is an object of the invention to provide a non-heat generating jig which eliminates the problems of the prior art and which is able to prevent adhesion of solder when reflow soldering is carried out, and to provide a method for connecting connection members using such an improved jig.

In order to accomplish the above object, according to the invention a non-heat generating jig to be in contact with solder in reflow soldering is provided with diamond-like-carbon (DLC) coating on at least a portion which is to be in contact with solder.

In a method for connecting connection members using a jig which is to be in contact with solder, according to the invention the jig is provided with diamond-like-carbon (DLC) coating on at least a portion which is to be in contact with solder.

The diamond-like-carbon (DLC) coating is an amorphous carbon film consisting mainly of carbon and hydrogen. Its hardness approximates to that of diamond. In contrast with diamond, moreover, as the diamond-like-carbon coating is amorphous, its surface is extremely smooth and significantly superior in wear resistance, non-adhesiveness, low friction, release properties and the like.

In a preferred embodiment of the invention, the jig is provided with the diamond-like-carbon coating on the whole surface which is to be in contact with solder. Preferably, the diamond-like-carbon coating has a thickness of at least 1 μm.

As can be seen from the above description, the jig and the method for connecting connection members using the jig can bring about the following significant effects.

(1) According to the invention, the jig which is to be in contact with solder in reflow soldering is provided with the diamond-like-carbon coating on at least a portion which is to be in contact with solder, so that the adhesion of solder is eliminated even if the jig contacts the solder during reflow soldering.

(2) In the method for connecting connection members using the jig according to the invention, as the jig is provided with the diamond-like-carbon coating on at least a portion to be in contact with solder, no adhesion of solder to the jig occurs and no fixation between the jig and the connection members (contact tails or the like) occurs.

(3) As no adhesion of solder to the jig occurs, no adhesion between the jig and the connection members (contact tails or the like) occurs and hence no adhesion between the jig and another member (a board and the like) occurs.

(4) According to the invention, there is no need for expensive and time-consuming surface treatment such as nickel-plating and anode oxidation for preventing adhesion of solder and improving corrosion resistance. According to the invention only applying the diamond-like-carbon coating to the surface of a jig can obtain an ideal surface remarkably superior in wear resistance, non-adhesiveness, low friction, release properties and the like to prevent the adhesion of solder.

The invention will be fully understood by referring to the following detailed specification and claims taken in connection with the appended drawings.

### BRIEF DESCRIPTION OF THE DRAWINGS

FIG. 1 is a perspective view of a connector and a jig according to the invention for explaining the function of the jig;

FIG. 2 is a side view of a state of contact tails of the connector shown in FIG. 1, urged against pads on a board by the jig;

FIG. 3A is a side view of a state of the contact tails urged against the pads of the board after reflow soldering;

FIG. 3B is a side view of a state with the jig removed after the step of FIG. 3A;

FIG. 4A is a perspective view of a connector for explaining a hitherto used jig; and

FIG. 4B is a side view of the connector shown in FIG. 4A.

### DESCRIPTION OF THE PREFERRED EMBODIMENTS

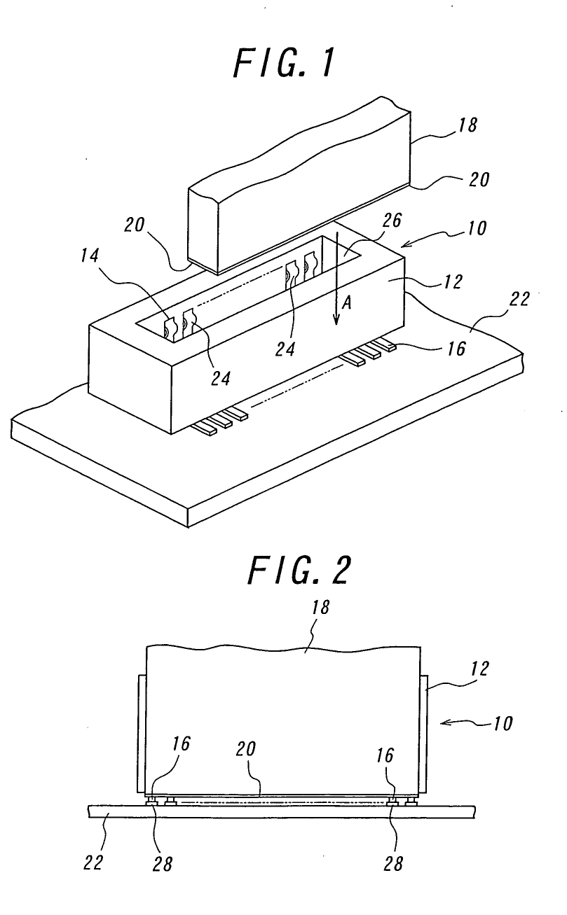

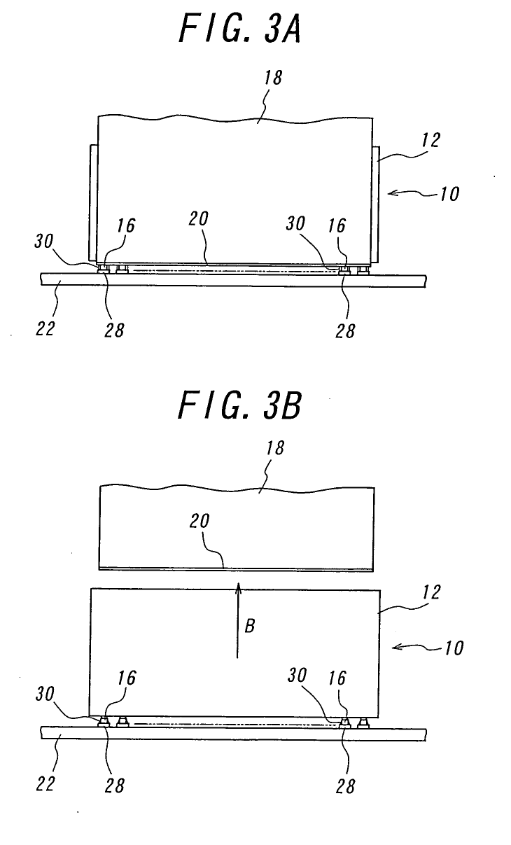

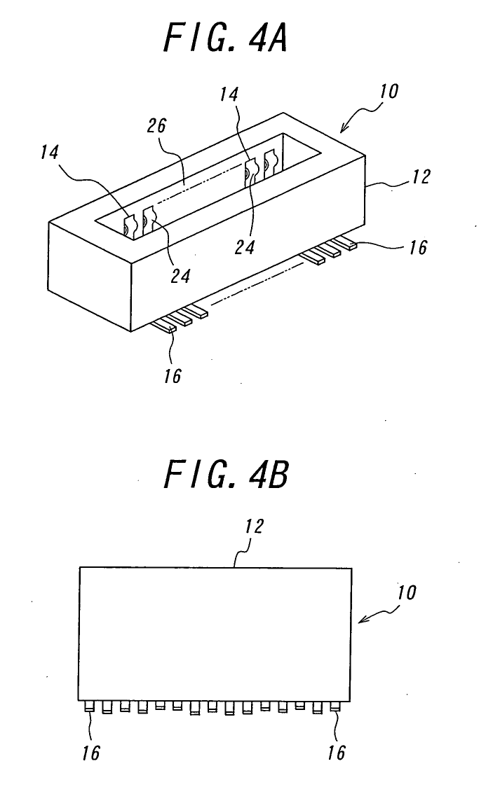

A non-heat generating jig of the invention will be explained exemplarily using a jig 18 for restraining contact tails 16 of a connector 10 illustrated in a perspective view of FIG. 1, which is substantially similar to the connector 10 exemplarily shown in the explanation for the prior art. FIG. 2 illustrates the jig 18 holding down the contact tails 16 of the connector 10 against pads 28 of a board 22. FIG. 3A shows a state similar to that of FIG. 2 but after reflow soldering, and FIG. 3B shows a state with the jig 18 removed.

As described in connection with the prior art, the connector 10 comprises a housing 12 and a plurality of contacts 14. The housing 12 is injection molded from an insulating plastic material and has a fitting opening 26 for fitting a mating connector. The contacts 14 are made of a metal superior in conductivity and springiness and formed by press-working in the conventional manner. Each of the contacts includes a contact portion 24 adapted to contact a mating contact, a fixing portion to be fixed to the housing 12 and a contact tail 16 to be connected to a circuit board 22.

The illustrated contact tails 16 are of a surface mounting type (SMT) so that the contact tails extend parallel to the surface of the board 22 as shown in FIG. 1. The electrical continuity of the connector 10 is completed by connecting the contact tails 16 to pads 28 of the board 22 by reflow soldering.

The jig 18 according to the invention will be explained hereinafter. The jig 18 serves to urge the contact tails against the pads 28 on the board 22 in the event that some of the contact tails do not contact the pads 28 due to variances in height of the contact tails when being mounted on the board. In order to reliably connect the tails of the contacts to the board, the jig 18 must be maintained in contact with molten solder during reflow soldering and further in contact with the solder during proceeding of its solidification. Therefore, the jig is bonded to the contact tails or the board with the solder in the same manner previously explained in connection with the prior art. In order to overcome this problem, according to the invention the jig 18 is coated with diamond like carbon 20 over at least portions of the jig which will contact the solder. The surface provided with the diamond like carbon coating is extremely smooth and significantly superior in wear resistance, non-adhesiveness, low-friction, release properties and the like to prevent the solder adhesion.

The jig 18 is moved in a direction of an arrow A in FIG. 1 to urge the contact tails 16 against the pads 28 on the board 22 shown in FIG. 2, under this condition the reflow soldering is performed to connect the contact tails 16 to the pads 28 shown in FIG. 3A. On completion of the reflow soldering, the jig 18 is moved away from the board in a direction of an arrow B as shown in FIG. 3B. No adhesion of the solder to the jig occurs because of the diamond like carbon coating 20 applied to the portions of the jig which the solder can contact.

Although the jig 18 is shown for urging the contact tails 16 to the pads 28 on the board 22, it is to be understood that the jig 18 is applicable to all processes for reflow soldering with molten solder in contact with a non-heat generating jig. For example, the jig according to the invention is applicable to a heater chip utilizing a pulse heating system, the tip of the heater chip being coated with the diamond-like-carbon. The jig according to the invention is also applicable to restraining jigs which are used in an infrared heating reflow furnace, a hot air reflow furnace, a vapor reflow furnace and others.

In carrying out the method according to the invention, used is the jig provided with the diamond-like-carbon coating on at least locations which tend to be in contact with the solder.

While the invention has been particularly shown and described with reference to the preferred embodiments thereof, it will be understood by those skilled in the art that the foregoing and other changes in form and details can be made therein without departing from the spirit and scope of the invention.

What is claimed is:

1. A non-heat generating jig to be in cold contact with cold contact tails and solder during reflow soldering to effect a solder bond between the contact tails and pads of a board, wherein said jig is provided with diamond-like-carbon coating on at least a portion which is to be in contact with the solder so that the non-adhesive nature of the diamond-like carbon coating is exploited to prevent adhesion between the jig and the solder.

2. The jig as set forth in claim 1 wherein said jig is provided with the diamond-like-carbon coating on the whole surface which is to be in contact with the solder.

3. The jig as set forth in claim 1 wherein the diamond-like-carbon coating has a thickness of at least 1 μm.

4. A method for connecting connection members using a non-heat generating jig which is to be in cold contact with cold contact tails and solder during reflow soldering to effect a solder bond between the contact tails and pads of a board, wherein the jig is provided with diamond-like-carbon coating on at least a portion which is to be in contact with the solder so that the non-adhesive nature of the diamond-like carbon coating is exploited to prevent adhesion between the jig and the solder.

5. The method of claim 4 wherein said jig is provided with the diamond-like-carbon coating on the whole surface which is to be in contact with the solder.

6. The method of claim 4 wherein said diamond-like-carbon coating has a thickness of at least 1 μm.
